(19) United States
(12) Patent Application Publication
(10) Pub. No.: US 2010/0271350 A1
(43) Pub. Date: Oct. 28, 2010

(54) LIQUID CRYSTAL DISPLAY

(76) Inventor: Wei-Chen CHUEH, Kaohsiung County (TW)

Correspondence Address: Muncy, Geissler, Olds & Lowe, PLLC, 4000 Legato Road, Suite 310, FAIRFAX, VA, 22033, US

(21) Appl. No.: 12/766,296

(22) Filed: Apr. 23, 2010

(30) Foreign Application Priority Data
Apr. 24, 2009 (TW) 98113590

(51) Int. Cl. G09G 5/00; G09G 3/36

(52) U.S. Cl. 345/205; 345/87

(57) ABSTRACT

A liquid crystal display including a panel and a chip driving the panel is provided. The panel has a first and a second input terminal and a segment of liquid crystal materials. The orientation of the liquid crystal materials is dependent on a voltage difference between the first and second input terminals. The chip has a plurality of output pins outputting rail-to-rail signals. The output pins are coupled to a connection node and the connection node is coupled to the first or second input terminal of the panel.

### CROSS REFERENCE TO RELATED APPLICATIONS

This Application claims priority of Taiwan Patent Application No. 098113590, filed on Apr. 24, 2009, the entirety of which is incorporated by reference herein.

### BACKGROUND OF THE INVENTION

1. Field of the Invention

The present invention relates to liquid crystal displays (LCDs), and in particular relates to driving designs thereof.

2. Description of the Related Art

One principle for driving an LCD panel is to rotate the orientation of liquid crystal materials thereof. Accordingly, transparency of liquid crystal materials can be controlled and images can be displayed. Polarity control terminals, such as a common mode terminal (corn) or a segment terminal (segment), of the LCD panel are typically designed to control the orientation of the liquid crystal materials.

The polarity control terminals may operate under a ½ bias technique or a ⅓ bias technique. The ½ bias technique uses three voltage levels to control the polarity control terminals. The ⅓ bias technique uses four voltage levels to control the polarity control terminals.

In view of this, it is an important topic to appropriately design an LCD panel driver to control the polarity control terminals for this field.

### BRIEF SUMMARY OF THE INVENTION

The invention discloses liquid crystal displays (LCDs) comprising a panel and a chip driving the panel.

The panel comprises a first input terminal, a second input terminal and a segment of liquid crystal materials. The orientation of the segment of liquid crystal materials is rotated according to a voltage difference between the first and second input terminals.

The chip comprises a plurality of output pins outputting rail-to-rail signals. Complementary metal-oxide-semiconductor (CMOS) inverters may be adopted in the chip to realize the rail-to-rail output signals.

For panels using the ½ bias technique, a first output pin and a second output pin of the chip are coupled to a connection node and the connection node is coupled to the first or second input terminals of the panel. According to the inputs of the CMOS inverters corresponding to the first and second output pins, the connection node is switched between a first, a second and a third voltage level and the coupled first or second input terminal of the panel is accordingly switched between the three voltage levels.

In some exemplary embodiments, the first output pin of the chip may be coupled to the connection node via an first resistor. The second output pin of the chip may be coupled to the connection node via a second resistor.

For panels using the ⅓ bias technique, first, second, third and fourth output pins of the chip are coupled to a connection node and the connection node is coupled to the first or second input terminals of the panel. According to the inputs of the CMOS inverters corresponding to the first, second third and fourth output pins, the connection node is switched between a first, a second, a third and a fourth voltage level and the coupled first or second input terminal of the panel is accordingly switched between the four voltage levels.

The first, second third and fourth output pins of the chip may be coupled to the connection node via first, second, third and fourth resistors, respectively.

Another exemplary embodiment of the LCD uses specially designed CMOS inverters to replace the chip with inherent CMOS inverters.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts an exemplary embodiment of a liquid crystal display (LCD) of the invention;

FIG. 2 depicts an embodiment of a portion of the chip 104;

FIG. 3 depicts another exemplary embodiment of the LCD of the invention;

FIG. 4 depicts an embodiment of a panel array;

FIG. 5 shows voltage waveforms illustrating a rule for driving the common mode terminals com₁, com₂ and com₃ and the segment terminal seg_{N} of the panel array of FIG. 4 under a ⅓ bias technique;

FIG. 6 depicts another exemplary embodiment of the LCD of the invention;

FIG. 7 depicts another exemplary embodiment of the LCD of the invention; and

FIG. 8 shows voltage waveforms diagram illustrating a rule for driving the segment line seg_{N} and the common mode lines com₁, com₂ and com₃ of the panel array shown in FIG. 4 under a ⅓ bias technique.

### DETAILED DESCRIPTION OF THE INVENTION

The following description shows several exemplary embodiments carrying out the invention. This description is made for the purpose of illustrating the general principles of the invention and should not be taken in a limiting sense. The scope of the invention is best determined by reference to the appended claims.

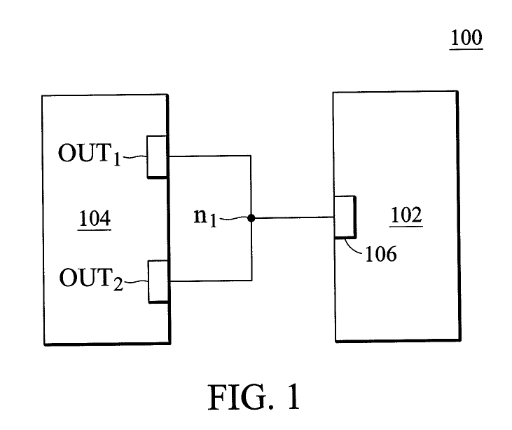

FIG. 1 depicts an exemplary embodiment of a liquid crystal display (LCD) of the invention, wherein the LCD 100 comprises a panel 102 and a chip 104 driving the panel.

The control principles of the panel 102 include rotating the orientation of the liquid crystal materials in the panel 102 to adjust the transparency of the liquid crystal materials to display images. The orientation of the liquid crystal materials is controlled by the voltage levels at polarity control terminals of the panel 102. One set of the polarity control terminals with a corresponding segment of liquid crystal materials in the panel 102 includes a common mode terminal (corn) and a segment terminal (segment). The orientation of the segment of liquid crystal materials rotates according to a voltage difference between the common mode terminal and the segment terminal. In the embodiment shown in FIG. 1, the input terminal 106 of the chip 102 serves as one of the polarity terminals. The input terminal 106 may be a common mode terminal or a segment terminal.

The chip 104 has an output pin OUT₁ and an output pin OUT₂ both outputting rail-to-rail signals. A rail-to-rail signal is a bi-stable signal, outputting either high or low voltage level. As shown, the output pins OUT₁ and OUT₂ are coupled to a connection node n₁ being coupled to the polarity control terminal 106 of the panel 102.

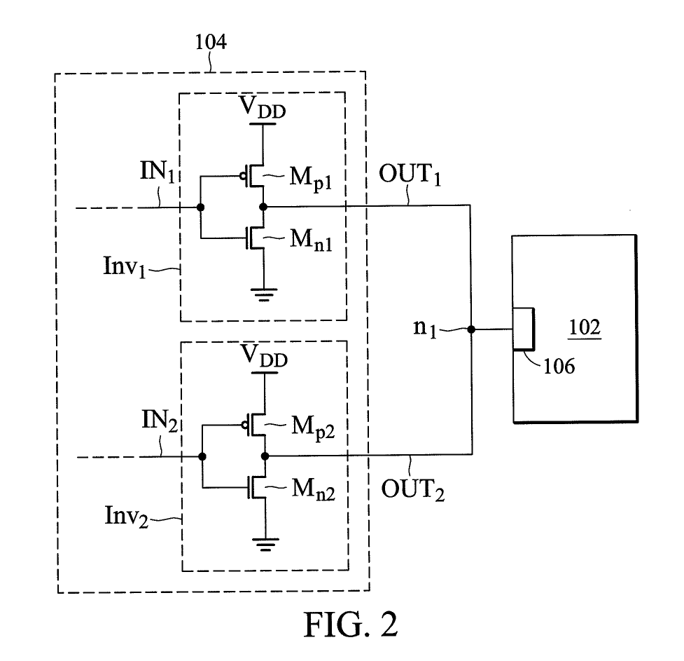

FIG. 2 depicts an embodiment of a portion of the chip 104. The chip 104 has a first complementary metal-oxide-semiconductor (CMOS) inverter Inv₁ and a second CMOS inverter Inv₂. The output terminals of the CMOS inverters Inv₁ and Inv₁ are coupled to the output pins OUT₁ and OUT₂ of the chip 104, respectively.

The CMOS inverter Inv₁ has a P-type metal-oxide-semiconductor (PMOS) Mₚ₁ and an N-type metal-oxide-semiconductor (NMOS) Mₙ₁ which are both coupled between a voltage source V_{DD} and ground GND. The CMOS inverter Inv₂ comprises a PMOS transistor Mₚ₂ and a NMOS Mₙ₂ both coupled between the voltage source V_{DD} and the ground GND. The transistors Mₚ₁, Mₙ₁, Mₚ₂ and Mₙ₂ each have a turn-on resistance. The chip 104 may control the input signals IN₁ and IN2 of the CMOS inverters Inv₁ and Inv₂ to control the voltage level of the connection node n₁. Accordingly, the connection node n₁ is switched between a first voltage level V_{DD}, a second voltage level GND and a third voltage level (between GND and V_{DD}).

In an exemplary embodiment of the invention, the fabrication processes of the PMOS Mₚ₁ and the NMOS Mₙ₂ are specially designed so that the PMOS Mₚ₁ and NMOS Mₙ₂ have the same turn-on resistance. TABLE 1 shows how the inputs IN₁ and IN₂ of the CMOS inverters Inv₁ and Inv₂ affect the voltage level of the connection node n₁.

TABLE 1

| IN₁ | IN₂ | Connection node n₁ |
|---|---|---|
| Logic ‘0’ | Logic ‘0’ | V_{DD} |
| Logic ‘1’ | Logic ‘1’ | GND |
| Logic ‘0’ | Logic ‘1 | V_{DD}/2 |

Thus, the polarity control terminal 106 may be switched among three voltage levels V_{DD}, GND and V_{DD}/2, and the panel 102 may work using a ½bias technique.

In another exemplary embodiment of the invention, the fabrication processes of the PMOS Mₚ₂ and NMOS Mₙ₁ are specially designed so that the PMOS Mₚ₂ and NMOS Mₙ₁ have the same turn-on resistance. TABLE 2 shows how the inputs IN₁ and IN₂ of the CMOS inverters Inv₁ and Inv₂ affect the voltage level of the connection node n₁.

TABLE 2

| IN₁ | IN₂ | Connection node n₁ |
|---|---|---|
| Logic ‘0’ | Logic ‘0’ | V_{DD} |
| Logic ‘1’ | Logic ‘1’ | GND |
| Logic ‘1’ | Logic ‘0’ | V_{DD}/2 |

Thus, the polarity control terminal 106 may be switched among three voltage levels V_{DD}, GND and V_{DD}/2, and the panel 102 may work using a ½bias technique.

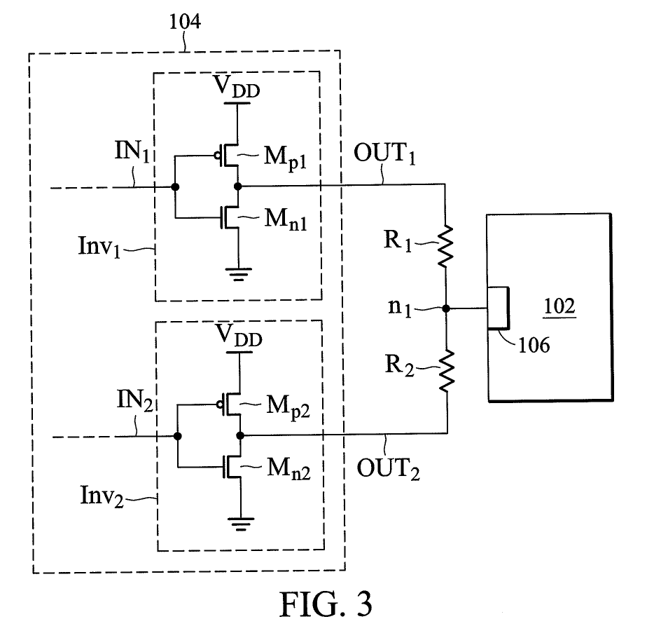

FIG. 3 depicts another exemplary embodiment of the LCDs of the invention. The output pin OUT₁ of the chip 104 is coupled to the connection node n₁ via a resistor R₁, and the output pin OUT₂ of the chip 104 is coupled to the connection node n₁ via a resistor R₂. The chip 104 can control the voltage level of the connection node n₁ by controlling the voltage levels of the input terminals IN₁ and IN₂ of the CMOS inverters Inv₁ and Inv₂. Accordingly, the connection node n₁ is switched between a first voltage level V_{DD}, a second voltage level GND and a third voltage level (between GND and V_{DD}). The value of the third voltage level is determined by the resistance of the resistors R₁, R₂ and the turn on resistances of the transistors of the CMOS inverters Inv₁ and Inv₂. The polarity control terminal 106 is switched among three voltage levels and the panel 102 may work using a ½ bias technique.

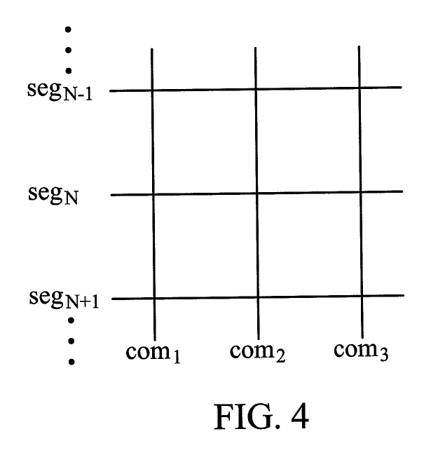

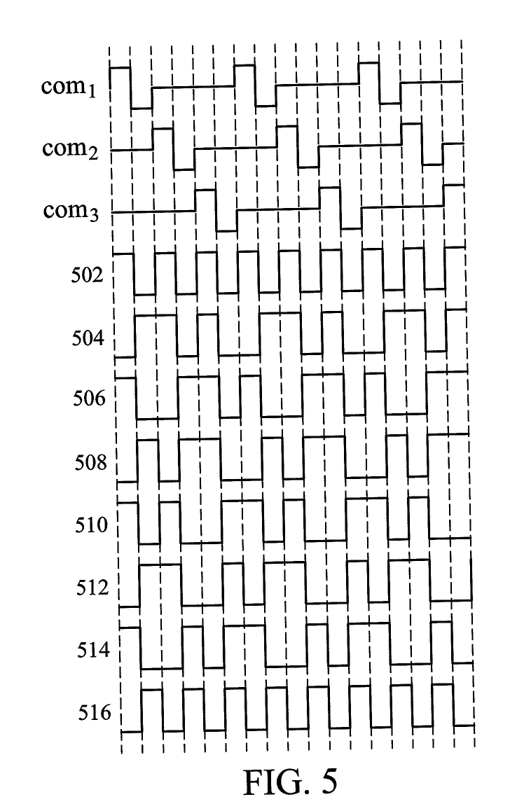

FIG. 4 depicts how polarity control lines (corresponding to the polarity control terminals) are deployed in a panel array, showing a common mode line com₁ (corresponding to the common mode terminal com₁), a common mode line com₂ (corresponding to the common mode terminal com₂), a common mode line com₃ (corresponding to the common mode terminal com₃), and several segment lines seg_{N-1}, seg_{N} and seg_{N+1} (corresponding to the segment terminals seg_{N-1}, seg_{N} and seg_{N+1}). FIG. 5 shows voltage waveforms applied on the common mode terminals com₁, com₂ and com₃ and the segment terminal seg_{N}, wherein for different operations the segment terminal seg_{N} is driven by different waveforms 502-516.

The voltage waveforms shown in FIG. 5 may be applied on the input terminal 106 shown in FIGS. 1-3, the input terminal 106 serve as the common mode terminal com₁, com₂ or com₃ or the segment terminal seg_{N}. Users can generate the voltage waveforms shown in FIG. 5 by controlling the voltage levels at the input terminals IN₁ and IN₂ of the CMOS inverters Inv₁ and Inv₂ of the chip 104.

The waveform for the common mode terminals com₁, com₂ and com₃ are periodical. During the duty period, the common mode polarity control terminal is raised to the first voltage level V_{DD} and then pulled down to the second voltage level GND to reverse the orientation of the liquid crystal materials. On unduty periods, the common mode polarity control terminal is maintained at the third voltage level V_{DD}/2. In a case shown in TABLE 1, users may repeat (‘0’, ‘1’, ‘0’, ‘0’, ‘0’, ‘0’) and (‘0’, ‘1’, ‘1’, ‘1’, ‘1’, ‘1’) at the input terminals IN₁ and IN₂ of the CMOS inverters Inv₁ and Inv₂ to generate the voltage waveforms for the common mode terminals com₁, com₂ and com₃.

The waveforms for the segment line seg_{N} are designed according to liquid crystal material characteristics. The liquid crystal material only turns on when the voltage difference between the corresponding segment line and common mode line is remained in voltage level V_{DD}. The segment terminal seg_{N} is applied different voltage waveforms 502˜516 for different panel control. When the segment terminal seg_{N} is driven by the voltage waveform 502, the segments of liquid crystal materials controlled by the segment line seg_{N} and all common mode lines com₁, com₂ and com₃ are turned off. The user may repeat (‘0’, ‘1’) and (‘0’, ‘1’) at the input terminals IN₁ and IN₂ of the CMOS inverters Inv₁ and Inv₂ to generate the voltage waveform 502. When the segment terminal seg_{N} is driven by the voltage waveform 504, the segment of liquid crystal materials controlled by the segment line seg_{N} and the common mode line com₁ is turned on. The user can repeat (‘1’, ‘0’, ‘0’, ‘1’, ‘0’, ‘1’) and (‘1’, ‘0’, ‘0’, ‘1’, ‘0’, ‘1’) at the input terminal IN₁ and IN₂ of the CMOS inverters Inv₁ and Inv₂ to generate the voltage waveform 504. When the segment terminal seg_{N} is driven by the voltage waveform 506, the segment of liquid crystal materials controlled by the segment line seg_{N} and the common mode line com₂ is turned on. The user can repeat (‘0’, ‘1’, ‘1’, ‘0’, ‘0’, ‘1’) and (‘0’, ‘1’, ‘1’, ‘0’, ‘0’, ‘1’) at the input terminals IN₁ and IN₂ of the CMOS inverters Inv₁ and Inv₂ to generate the voltage waveform 506. When the segment terminal seg_{N} is driven by the voltage waveform 508, the segments of liquid crystal materials controlled by the segment line seg_{N} and the common mode lines com₁ and com₂ are turned on. The user can repeat (‘1’, ‘0’, ‘1’, ‘0’, ‘0’, ‘1’) and (‘1’, ‘0’, ‘1’, ‘0’, ‘0’, ‘1’) at the input terminals IN₁ and IN₂ of the CMOS inverters Inv₁ and Inv₂ to generate the voltage waveform 508. When the segment terminal seg_{N} is driven by the voltage waveform 510, the segment of liquid crystal materials controlled by the segment line seg_{N} and the common mode line com₃ is turned on. The user can repeat (‘0’, ‘1’, ‘0’, ‘1’, ‘1’, ‘0’) and (‘0’, ‘1’, ‘0’, ‘1’, ‘1’, ‘0’) at the input terminals IN₁ and IN₂ of the CMOS inverters Inv₁ and Inv₂ to generate the voltage waveform 510. When the segment terminal seg_{N} is driven by the voltage waveform 512, the segments of liquid crystal materials controlled by the segment line seg_{N} and the common mode lines com₁ and com₃ are turned on. The user can repeat (‘1’, ‘0’, ‘0’, ‘1’, ‘1’, ‘0’) and (‘1’, ‘0’, ‘0’, ‘1’, ‘1’, ‘0’) at the input terminals IN₁ and IN₂ of the CMOS inverters Inv₁ and Inv₂ to generate the voltage waveform 512. When the segment terminal seg_{N} is driven by the voltage waveform 514, the segments of liquid crystal materials controlled by the segment line seg_{N} and the common mode lines com₂ and com₃ are turned on. The user may repeat (‘0’, ‘1’, ‘1’, ‘0’, ‘1’, ‘0’) and (‘0’, ‘1’, ‘1’, ‘0’, ‘1’, ‘0’) at the input terminals IN₁ and IN₂ of the CMOS inverters Inv₁ and Inv₂ to generate the voltage waveform 514. When the segment line seg_{N} is driven by the voltage waveform 516, the segments of liquid crystal materials controlled by the segment line seg_{N} and all common mode lines com₁, com₂ and com₃ are turned on. The user can repeat (‘1’, ‘0’, ‘1’, ‘0’, ‘1’, ‘0’) and (‘1’, ‘0’, ‘1’, ‘0’, ‘1’, ‘0’) at the input terminals IN₁ and IN₂ of the CMOS inverters Inv₁ and Inv₂ to generate the voltage waveform 516.

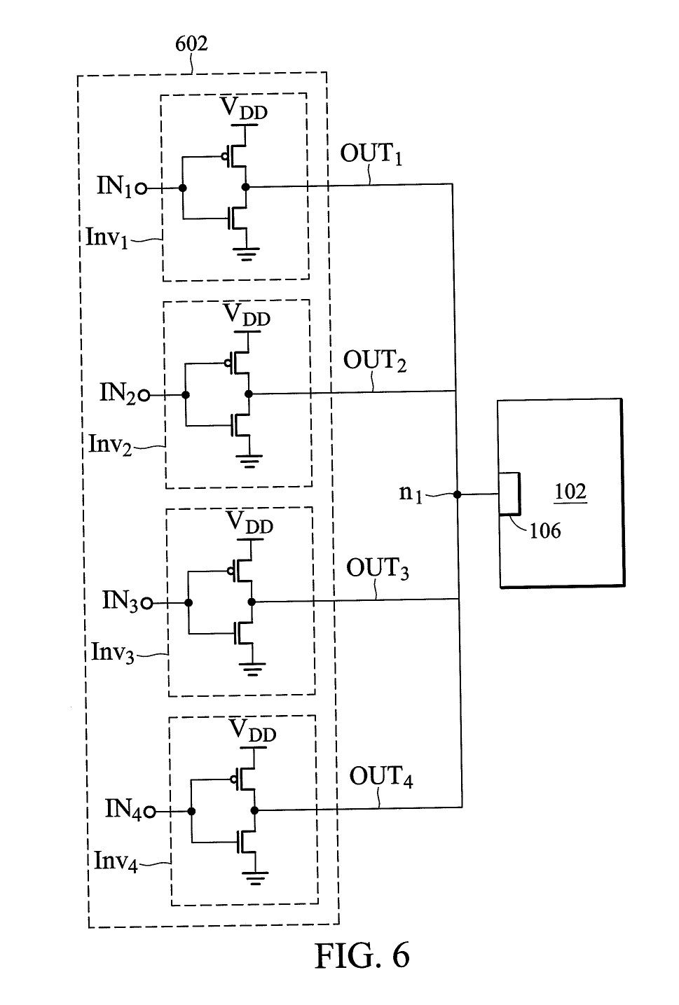

FIG. 6 depicts another exemplary embodiment of the LCD of the invention. Compared with the chip 104 of FIG. 2, the chip 602, driving the panel 102, further comprises an output pin OUT₃ and an output pin OUT₄. The third and fourth output pins OUT₃ and OUT₄ output rail-to-rail signals and are coupled to the connection node n₁ as the output pins OUT₁ and OUT₂. As shown, the chip 602 realizes rail-to-rail outputs by CMOS inverters. The output terminals of the CMOS inverters Inv₃ and Inv₄ are coupled to the output pins OUT₃ and OUT₄, respectively.

The transistors of the CMOS inverters Inv₁˜Inv₄ each have a turn on resistance. The chip 602 controls the inputs IN₁-IN₄ of the CMOS inverters Inv₁-Inv₄ to switch the connection node n₁ between a first voltage level V_{DD}, a second voltage level GND, a third voltage level (such as V_{DD}/3) and a fourth voltage level (such as 2V_{DD}/3). Thus, the panel 102 may work according to a ⅓ bias technique.

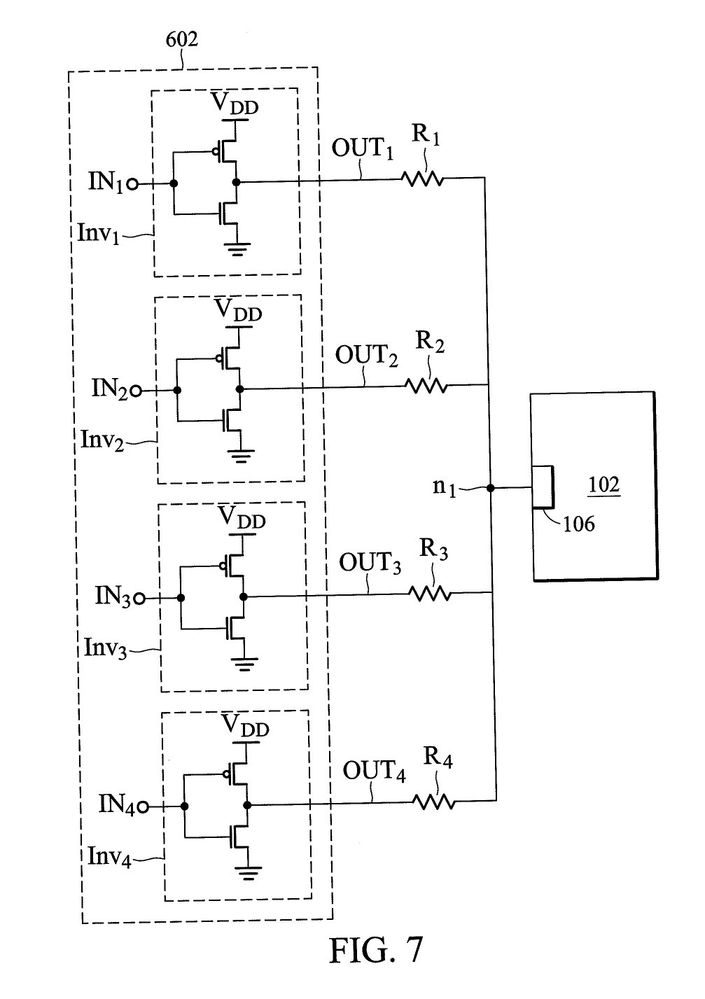

FIG. 7 depicts another exemplary embodiment of the LCDs of the invention. The output pins OUT₁-OUT₄ of the chip 602 are coupled to the connection node n₁ through resistors R₁-R₄, respectively. The resistance of the resistors R₁-R₄ are specially designed to switch the connection node n₁ between a first voltage level V_{DD}, a second voltage level GND, a third voltage level (such as V_{DD}/3), and a fourth voltage level (such as 2V_{DD}/3). The panel 102 may work according to a ⅓ bias technique.

For a case wherein the fabrication processes or the resistors R₁-R₄ are specially designed, TABLE 3 shows how the inputs IN₁-IN₄ of the CMOS inverters Inv₁-Inv₄ affect the voltage level of the connection node n₁.

TABLE 3

| | | | | Connection |
|---|---|---|---|---|
| IN₁ | IN₂ | IN₃ | IN₄ | node n₁ |
| Logic ‘0’ | Logic ‘0’ | Logic ‘0’ | Logic ‘0’ | V_{DD} |
| Logic ‘1’ | Logic ‘1’ | Logic ‘1’ | Logic ‘1’ | GND |
| Logic ‘0’ | Logic ‘0’ | Logic ‘1’ | Logic ‘1’ | V_{DD}/3 |
| Logic ‘1’ | Logic ‘1’ | Logic ‘0’ | Logic ‘1’ | 2V_{DD}/3 |

The polarity control terminal 106 may be switched between four voltage levels V_{DD}, GND, V_{DD}/3 and 2V_{DD}/3. The panel 102 may work according to a ⅓ bias technique.

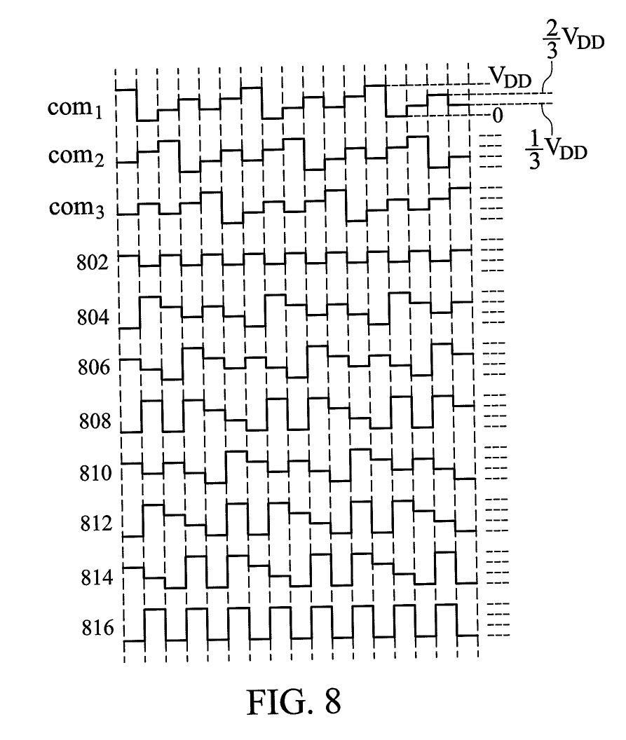

FIG. 8 shows voltage waveforms driving segments of liquid crystal materials controlled by the segment line seg_{N} and the common mode lines com₁, com₂ and com₃, wherein a ⅓ bias technique is used. For different operations, the segment line seg_{N} may be driven by different voltage waveforms 802˜816. The user can control the voltage levels at the input terminals IN₁-IN₄ of the CMOS inverters Inv₁-Inv₄ of the chip 602 to achieve the voltage waveforms shown in FIG. 8.

The waveform for the common mode terminals com₁, com₂ and com₃ are periodical. During the duty period, the common mode polarity control terminal is raised to the first voltage level V_{DD} and then pulled down to the second voltage level GND to reverse the orientation of the liquid crystal materials. Outside of the duty periods, the common mode polarity control terminal is switched between the third and fourth voltage levels V_{DD}/3 and 2V_{DD}/3. When the chip 602 works according to the rule shown in TABLE 3, the user can repeat (‘0’, ‘1’, ‘0’, ‘1’, ‘0’, ‘1’), (‘0’, ‘1’, ‘0’, ‘1’, ‘0’, ‘1’), (‘0’, ‘1’, ‘1’, ‘0’, ‘1’, ‘0’) and (‘0’, ‘1’, ‘1’, ‘1’, ‘1’, ‘1’) at the input terminals IN₁-IN₄ of the CMOS inverters Inv₁-Inv₄ to generate the voltage waveforms for the common mode terminals com₁, com₂ and com₃.

The waveforms for the segment line seg_{N} are designed according to liquid crystal material characteristics. The liquid crystal material only turns on when the corresponding segment line and common mode line provide a voltage difference V_{DD}. When the segment line seg_{N} is applied the voltage waveform 802, the segment of liquid crystal materials controlled by the segment line segN and all common mode lines com₁, com₂ and com₃ are turned off. The user can repeat (‘1’, ‘0’, ‘1’, ‘0’, ‘1’, ‘0’), (‘1’, ‘0’, ‘1’, ‘0’, ‘1’, ‘0’), (‘0’, ‘1’, ‘0’, ‘1’, ‘0’, ‘1’) and (‘1’, ‘1’, ‘1’, ‘1’, ‘1’, ‘1’) at the input terminals IN₁-IN₄ of the inverters Inv₁-Inv₄ to generate the voltage waveform 802. When the segment line seg_{N} is driven by the voltage waveform 804, the segment of liquid crystal materials controlled by the segment line seg_{N} and the common mode line com₁ is turned on. The user can repeat (‘1’, ‘0’, ‘1’, ‘0’, ‘1’, ‘0’), (‘1’, ‘0’, ‘1’, ‘0’, ‘1’, ‘0’), (‘1’, ‘0’, ‘0’, ‘1’, ‘0’, ‘1’) and (‘1’, ‘0’, ‘1’, ‘1’, ‘1’, ‘1’) at the input terminals IN₁-IN₄ of the inverters Inv₁-Inv₄ to generate the voltage waveform 804. When the segment lien seg_{N} is driven by the voltage waveform 806, the segment of liquid crystal material controlled by the segment line seg_{N} and the common mode line com₂ is turned on. The user can repeat (‘1’, ‘0’, ‘1’, ‘0’, ‘1’, ‘0’), (‘1’, ‘0’, ‘1’, ‘0’, ‘1’, ‘0’), (‘0’, ‘1’, ‘1’, ‘0’, ‘0’, ‘1’) and (‘1’, ‘1’, ‘1’, ‘0’, ‘1’, ‘1’) at the input terminals IN₁-IN₄ of the inverters Inv₁-Inv₄to generate the voltage waveform 806. When the segment line seg_{N} is driven by voltage waveform 808, the segments of liquid crystal materials controlled by the segment line seg_{N} and the common mode lines com₁ and com₂ are turned on. The user can repeat (‘1’, ‘0’, ‘1’, ‘0’, ‘1’, ‘0’), (‘1’, ‘0’, ‘1’, ‘0’, ‘1’, ‘0’), (‘1’, ‘0’, ‘1’, ‘0’, ‘0’, ‘1’) and (‘1’, ‘0’, ‘1’, ‘0’, ‘1’, ‘1’) at the input terminals IN₁-IN₄ of the inverters Inv₁-Inv₄ to generate the voltage waveform 808. When the segment line seg_{N} is driven by the voltage waveform 810, the liquid crystal materials controlled by the segment line seg_{N} and the common mode line com₃ is turned on. The user can repeat (‘1’, ‘0’, ‘1’, ‘0’, ‘1’, ‘0’), (‘1’, ‘0’, ‘1’, ‘0’, ‘1’, ‘0’), (‘0’, ‘1’, ‘0’, ‘1’, ‘1’, ‘0’) and (‘1’, ‘1’, ‘1’, ‘1’, ‘1’, ‘0’) at the input terminals IN₁-IN₄ of the inverters Inv₁-Inv₄to generate the voltage waveform 810. When the segment line seg_{N} is driven by the voltage waveform 812, the segments of liquid crystal materials controlled by the segment line seg_{N} and the common mode lines com₁ and com₃ are turned on. The user can repeat (‘1’, ‘0’, ‘1’, ‘0’, ‘1’, ‘0’), (‘1’, ‘0’, ‘1’, ‘0’, ‘1’, ‘0’) and (‘1’, ‘0’, ‘0’, ‘1’, ‘1’, ‘0’) and (‘1’, ‘0’, ‘1’, ‘1’, ‘1’, ‘0’) at the input terminals IN₁-IN₄ of the inverters Inv'-Inv₄ to generate the voltage waveform 812. When the segment line seg_{N} is driven by the voltage waveform 814, the segments of liquid crystal materials controlled by the segment line seg_{N} and the common mode lines com₂ and com₃ are turned on. The user can repeat (‘1’, ‘0’, ‘1’, ‘0’, ‘1’, ‘0’), (‘1’, ‘0’, ‘1’, ‘0’, ‘1’, ‘0’), (‘0’, ‘1’, ‘1’, ‘0’, ‘1’, ‘0’) and (‘1’, ‘0’, ‘1’, ‘0’) at the input terminals IN₁-IN₄ of the inverters Inv₁-Inv₄ to generate the voltage waveform 814. When the segment line seg_{N} is driven by the voltage waveform 816, the segments of liquid crystal materials controlled by the segment line seg_{N} and all common mode lines com₁, com₂ and com₃ are turned on. The user can repeat (‘1’, ‘0’), (‘1’, ‘0’), (‘1’, ‘0’) and (‘1’, ‘0’) at the input terminals IN₁-IN₄ of the inverters Inv₁-Inv₄ to generate the voltage waveform 816.

The aforementioned chip (104 or 602) may be Vacuum fluorescent display (VFD) driving chip or any chip which use CMOS inverters to achieve rail-to-rail outputs.

In other exemplary embodiments of the LCDs of the invention, the aforementioned CMOS inverters are specially designed rather than inherent in a chip with rail-to-rail outputs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display, comprising
a panel having a first input terminal, a second input terminal and a segment of liquid crystal materials, wherein the segment of liquid crystal materials is rotated according to a voltage difference between the first and second input terminals; and
a chip for driving the panel, the chip has a first output pin and a second output pin, wherein both the first and second output pins output rail-to-rail signals,
wherein the first and second output pins of the chip are coupled to a connection node, and the connection node is coupled to the first or second input terminal of the panel.

2. The liquid crystal display as claimed in claim 1, wherein the chip includes a first complementary metal-oxide-semiconductor (CMOS) inverter and a second CMOS inverter, and output terminals of the first and second CMOS inverters are coupled to the first and second output pins of the chip, respectively.

3. The liquid crystal display as claimed in claim 2, wherein the panel works according to a ½ bias technique.

4. The liquid crystal display as claimed in claim 3, wherein the chip switches the connection node among a first voltage level, a second voltage level and a third voltage level by controlling voltage levels of input terminals of the first and second CMOS inverters.

5. The liquid crystal display as claimed in claim 4, wherein the first output pin of the chip is coupled to the connection node through a first resistor.

6. The liquid crystal display as claimed in claim 4, wherein the second output pin of the chip is coupled to the connection node through a second resistor.

7. The liquid crystal display as claimed in claim 2, wherein the chip further comprises third and fourth output pins outputting rail-to-rail signals and coupled to the connection node.

8. The liquid crystal display as claimed in claim 7, wherein the chip further comprises a third CMOS inverter and a fourth CMOS inverter, and output terminals of the third and fourth CMOS inverters are coupled to the third and fourth output pins of the chip, respectively.

9. The liquid crystal display as claimed in claim 8, wherein the panel works according to a ⅓ bias technique.

10. The liquid crystal display as claimed in claim 9, wherein the chip switches the connection node among a first voltage level, a second voltage level, a third voltage level and a fourth voltage level.

11. The liquid crystal display as claimed in claim 10, wherein the third output pin of the chip is coupled to the connection node through a third resistor.

12. The liquid crystal display as claimed in claim 10, the fourth output pin of the chip is coupled to the connection node through a fourth resistor.

13. A liquid crystal display, comprising:
a panel having a first input terminal, a second input terminal and a segment of liquid crystal materials which rotates according to a voltage difference between the first and second input terminals; and
a first complementary metal-oxide-semiconductor (CMOS) inverter and a second CMOS inverter,
wherein output terminals of the first and second CMOS inverters are coupled to a connection node, and the connection node is coupled to the first or second input terminal of the panel.

14. The liquid crystal display as claimed in claim 13, wherein the panel works according to a ½ bias technique, and the connection node is switched among a first voltage level, a second voltage and a third voltage level by input signals of the first and second CMOS inverters.

15. The liquid crystal display as claimed in claim 14, the output terminal of the first CMOS inverter is coupled to the connection node through a first resistor.

16. The liquid crystal display as claimed in claim 14, the output terminal of the second CMOS inverter is coupled to the connection node through a second resistor.

17. The liquid crystal display as claimed in claim 13, further comprising a third CMOS inverter and a fourth CMOS inverter having output terminals coupled to the connection node.

18. The liquid crystal display as claimed in claim 17, wherein the panel works according to a ⅓ bias technique, and input signals of the first, second, third and fourth CMOS inverters switch the connection node among a first voltage level, a second voltage level, a third voltage level and a fourth voltage level.

19. The liquid crystal display as claimed in claim 18, the output terminal of the third CMOS inverter is coupled to the connection node through a third resistor.

20. The liquid crystal display as claimed in claim 18, the output terminal of the fourth CMOS inverter is coupled to the connection node through a fourth resistor.
